(19) United States
(12) Patent Application Publication
(10) Pub. No.: US 2021/0146641 A1
(43) Pub. Date: May 20, 2021

(54) BICYCLE TIRE REPAIR DEVICE

(71) Applicant: Louis CHUANG, Taichung (TW)

(72) Inventor: Louis CHUANG, Taichung (TW)

(21) Appl. No.: 17/026,531

(22) Filed: Sep. 21, 2020

(30) Foreign Application Priority Data
Nov. 19, 2019 (TW) 108141899

(51) Int. Cl. B29C 73/08; B62J 11/22

(52) U.S. Cl. CPC B29C 73/08; B62J 11/22

(57) ABSTRACT

A bicycle tire repair device has a main body having a first working end which has an air inlet port useful for connecting with an object that outputs air and an air outlet port useful for receiving a valve of a tire to be repaired and a second working end which includes a tire repair needle being movable between an extended position and a retracted position. The tire repair needle is pivotally connected with the main body.

### BACKGROUND OF THE INVENTION

### 1. Field of the Invention

The present invention relates to a tire repair device and, particularly, to a tire repair device for repairing bicycle tires.

### 2. Description of the Related Art

Taiwan Pat. No. 1625203 discloses a folding tool kit useful for repairing tires. The folding tool kit includes a main body with two side plates spaced from each other, a shaft between the two plates, and a wide variety of tools pivotally connected to the shaft. The folding tool kit may be useful, but does not help a user inflate a repaired tire. Although the user can bring along an inflating device or high-pressure gas cylinders with the folding tool kit, it is burdensome.

The present invention is, therefore, intended to obviate or at least alleviate the problems encountered in the prior art.

### SUMMARY OF THE INVENTION

A bicycle tire repair device in accordance with the present invention has a main body which has a first end forming a working end useful for repairing and fluidly connecting with a tire to be repaired and a second end forming an air inlet end useful for connecting with an object that outputs air. The main body defines a channel between the air inlet end and the working end for allowing the air from the object to flow to the second end. The first end includes a tire repair needle connected therewith.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of a bicycle tire repair device in accordance with the present invention.

FIG. 2 is an exploded perspective view of the bicycle tire repair device.

FIG. 3 is a perspective view illustrating the bicycle tire repair device in a position for inserting a repair tire strip into a tire to be repaired.

FIG. 4 is a cross-sectional of FIG. 3.

FIG. 5 is a cross-sectional view illustrating the bicycle tire repair device inserting a repair tire strip into a tire to be repaired.

FIG. 6 is a cross-sectional view illustrating the bicycle tire repair device fluidly connected to a valve of the repaired tire for inflating the repaired tire.

FIG. 7 is a perspective view illustrating the bicycle tire repair device stowed on a bicycle.

### DETAILED DESCRIPTION OF THE INVENTION

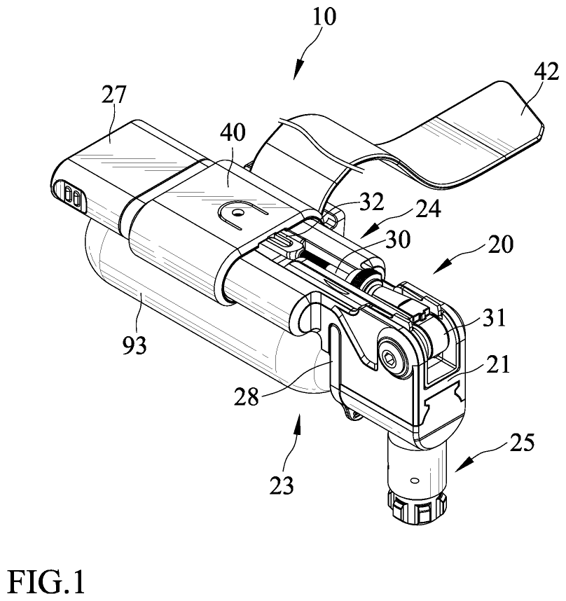

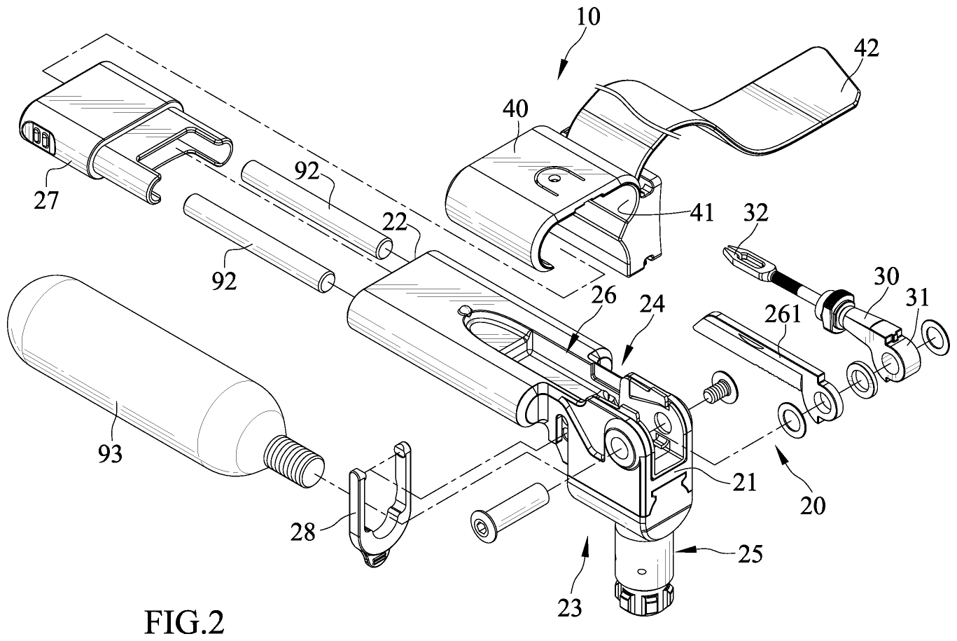

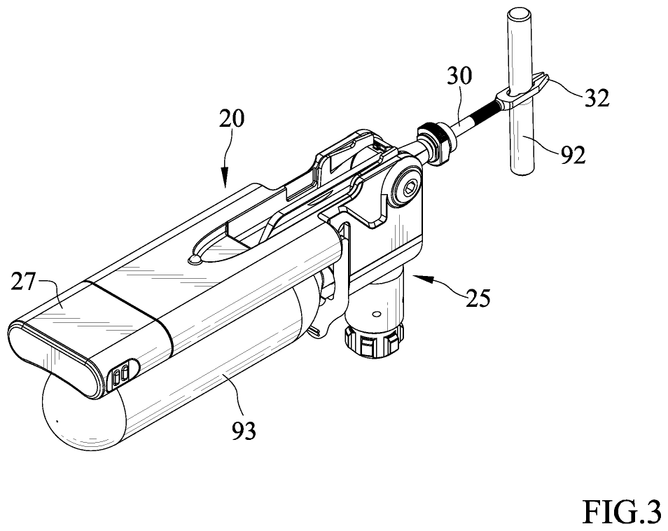

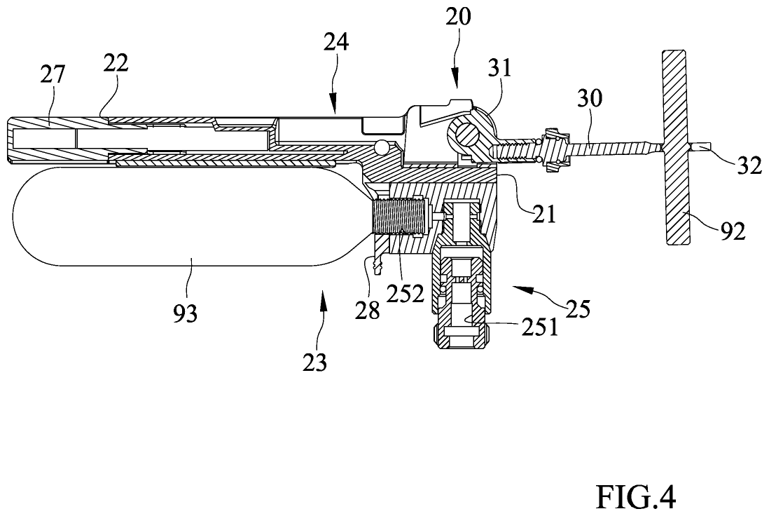

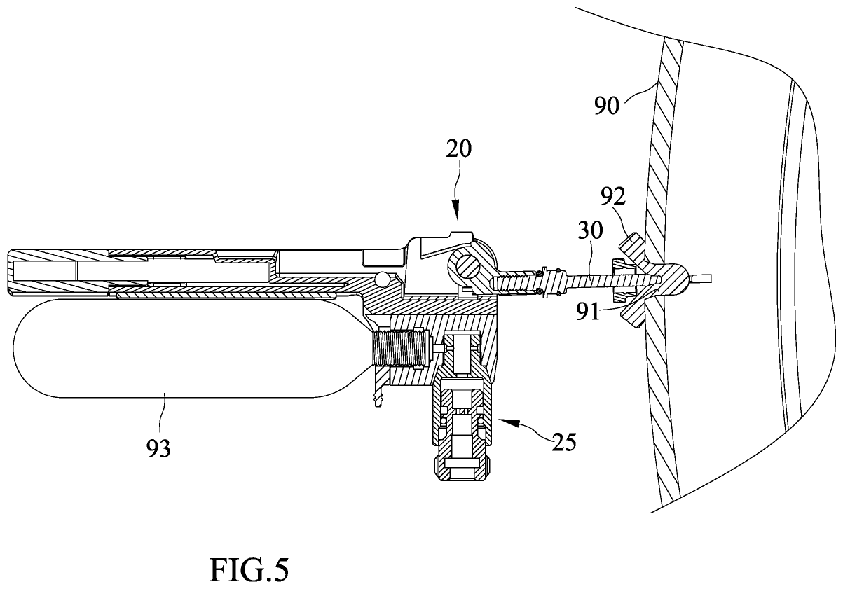

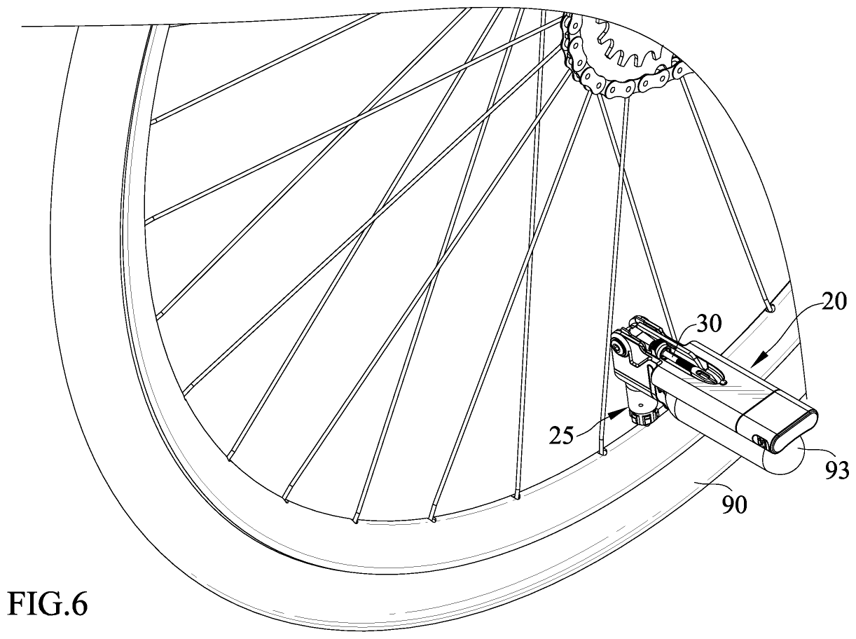

FIGS. 1 through 7 show a bicycle tire repair device 10 in accordance with the present invention.

A main body 20 has an end 21 and an end 22 opposite the end 21. The main body 20 extends from the end 21 to the end 22 along a length direction thereof. The main body 20 has a side 23 and a side 24 opposite the side 23. The main body 20 has a working end 25 which has an air inlet port 251 useful for connecting with an object 93 that outputs air and an air outlet port 252 useful for receiving a valve of a tire 90 to be repaired. Particularly, the air inlet port 251 defines a space for receiving the object 93 and the air outlet port 252 defines a space for receiving the valve of the tire 90 to be repaired, respectively. Particularly, the object 93 is a high-pressure gas cylinder. More particularly, the object 93 has threads and the air inlet port 251 has threads engageable with the threads of the object 93. The air inlet port 251 is fluidly communicated with the air outlet port 252. Accordingly, the object 93 outputs air to inflate the tire 90 to be repaired.

Moreover, the working end 25 is at the side 23. The working end 25 is adjacent to the end 21. The air inlet port 251 and the air outlet port 252 open at different directions. The air inlet port 251 opens in a direction toward the end 22. When the valve of the tire 90 to be repaired is connected with the air outlet port 252, it is disposed transversely to the main body 20. When the object 93 is connected with the air inlet port 251, it is disposed parallel to the main body 20.

Further, the main body 20 has a working end 26 which includes a tire repair needle 30 being movable between an extended position and a retracted position. The working end 26 is at the side 24. The working ends 25 and 26 are at different sides of the main body 20. The working end 26 is adjacent to the end 21. The tire repair needle 30 has a fixed end 31 pivotally connected with the main body 20. The tire repair needle 30 is movably connected with the main body 20. The tire repair needle 30 is configured to hold a tire repair strip 92 and to insert the tire repair strip 92 into the tire 90 to be repaired. The tire repair needle 30 has a free end 32 on which the tire repair strip 92 is mounted. The tire repair needle 30, in the retracted position, extends toward the end 22. The tire repair needle 30, in the extended position, extends away from the end 22. Accordingly, a user drives the tire repair needle 30, which is in the extended position, to push the tire repair strip 92 into a puncture 91 of the tire 90 to be repaired until the puncture 91 is sealed.

Further, the main body 20 has a hollow interior with an opening for storing the tire repair strip 92 and a cap 27 selectively closing and opening the opening of the hollow interior, and so the cap 27 prevents the tire repair strip 92 from dropping outside the hollow interior of the main body. The cap 27 is detachable from the main body 20.

A bicycle tool 261 is connected with the main body 20. The bicycle tool 261 is movable between an extended position and a retracted position. The bicycle tool 261 is pivotally connected with the main body 20. The bicycle tool 261 and the tire repair needle 30 are pivotal about an axis. The bicycle tool 261 is a cutting tool, but not limited thereto.

A support 28 is coupled to the main body 20 for bearing the object 93. The support 28 is U-shaped and has two separate ends connected with the main body 20.

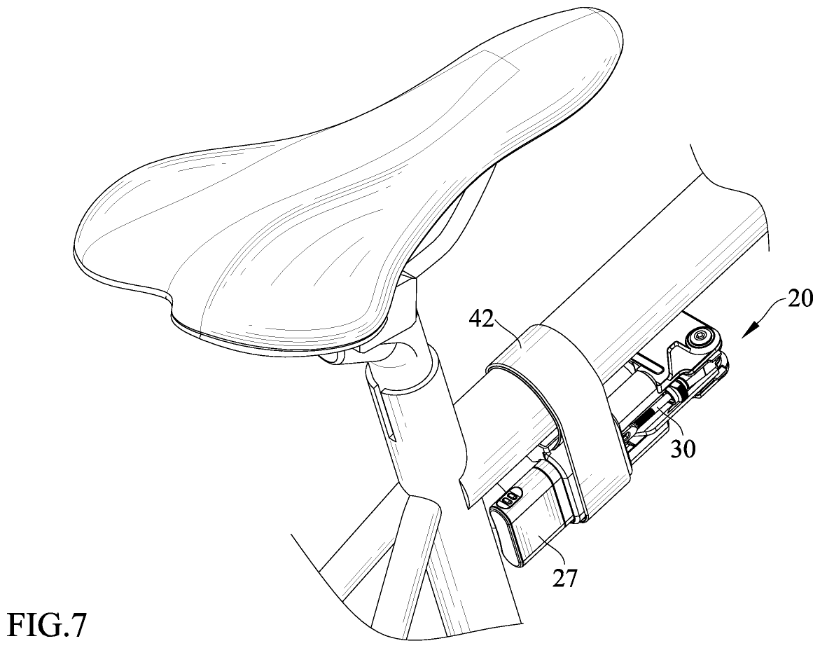

A mount 40 is mountable on a bicycle. The mount 40 has an attaching portion 42 for attaching to the bicycle. FIG. 7 shows the mount 40 is attached to a frame of the bicycle. The attaching portion 42 is a flexible strap. The mount 40 can be attached to the frame by wrapping the attaching portion 42 around the frame. The mount 40 has a holding portion 41 for releasably holding the main body 20. Particularly, the holding portion 41 is elastic. When the mount 40 and the main body 20 are to be carried by the bicycle, the mount 40 is attached to the bicycle and the main body 20 is held by the holding portion 41, respectively.

In view of the foregoing, the bicycle tire repair device 10 allows a user to fix the tire 90 to be repaired conveniently. Further, the bicycle tire repair device 10 is portable and can be attached to the frame of the bicycle.

The foregoing is merely illustrative of the principles of this invention, and various modifications can be made by those skilled in the art without departing from the scope and spirit of the invention.

What is claimed is:

1. A bicycle tire repair device comprising:
a main body having a first working end which has an air inlet port useful for connecting with an object that outputs air and an air outlet port useful for receiving a valve of a tire to be repaired and a second working end which includes a tire repair needle being movable between an extended position and a retracted position, and wherein the tire repair needle has a fixed end pivotally connected with the main body.

2. The bicycle tire repair device as claimed in claim 1, wherein the first working end and the second working end are at different sides of the main body.

3. The bicycle tire repair device as claimed in claim 1, wherein the working end is adjacent to a first end of the main body, and wherein the main body has a second end opposite the first end and extends from the first end to the second end along a length direction thereof.

4. The bicycle tire repair device as claimed in claim 3, wherein the air inlet port and the air outlet port open at different directions.

5. The bicycle tire repair device as claimed in claim 4, wherein the air inlet port opens in a direction toward the second end of the main body.

6. The bicycle tire repair device as claimed in claim 3, wherein the tire repair needle is configured to hold a tire repair strip and to insert the tire repair strip into the tire to be repaired, wherein the tire repair needle has a free end on which the tire repair strip is mounted, wherein the tire repair needle, in the retracted position, extends toward the second end of the main body, and wherein the tire repair needle, in the extended position, extends away from the second end of the main body.

7. The bicycle tire repair device as claimed in claim 6 further comprising a bicycle tool connected with the main body, wherein the bicycle tool is movable between an extended position and a retracted position, wherein the tool is pivotally connected with the main body, and wherein the bicycle tool and the tire repair needle are pivotal about an axis.

8. The bicycle tire repair device as claimed in claim 1, wherein the main body has a hollow interior with an opening for storing a tire repair strip and a cap selectively closing and opening the opening of the hollow interior.

9. The bicycle tire repair device as claimed in claim 1 further comprising a support coupled to the main body for bearing the object.

10. The bicycle tire repair device as claimed in claim 1 further comprising a mount mountable on a bicycle, wherein the mount has an attaching portion for attaching to the bicycle, wherein the mount has a holding portion for releasably holding the main body, and wherein when the mount and the main body are to be carried by the bicycle, the mount is attached to the bicycle and the main body is held by the holding portion, respectively.

11. The bicycle tire repair device as claimed in claim 10, wherein the holding portion is elastic.

12. The bicycle tire repair device as claimed in claim 11, wherein the attaching portion is a flexible strap.

13. The bicycle tire repair device as claimed in claim 6, wherein the main body has a hollow interior with an opening for storing a tire repair strip and a cap selectively closing and opening the opening of the hollow interior.

14. The bicycle tire repair device as claimed in claim 7, wherein the main body has a hollow interior with an opening for storing a tire repair strip and a cap selectively closing and opening the opening of the hollow interior.

15. The bicycle tire repair device as claimed in claim 13 further comprising a mount mountable on a bicycle, wherein the mount has an attaching portion for attaching to the bicycle, wherein the mount has a holding portion for releasably holding the main body, and wherein when the mount and the main body are to be carried by the bicycle, the mount is attached to the bicycle and the main body is held by the holding portion, respectively.

16. The bicycle tire repair device as claimed in claim 14 further comprising a mount mountable on a bicycle, wherein the mount has an attaching portion for attaching to the bicycle, wherein the mount has a holding portion for releasably holding the main body, and wherein when the mount and the main body are to be carried by the bicycle, the mount is attached to the bicycle and the main body is held by the holding portion, respectively.

17. The bicycle tire repair device as claimed in claim 15 further comprising a support coupled to the main body for bearing the object.

18. The bicycle tire repair device as claimed in claim 16 further comprising a support coupled to the main body for bearing the object.

19. The bicycle tire repair device as claimed in claim 18, wherein the air inlet port and the air outlet port open at different directions.

20. The bicycle tire repair device as claimed in claim 19, wherein the air inlet port and the air outlet port open at different directions.
